(19) United States
(12) Patent Application Publication
(10) Pub. No.: US 2021/0312229 A1
(43) Pub. Date: Oct. 7, 2021

(54) SELECTING UNLABELED DATA OBJECTS TO BE PROCESSED

(71) Applicant: Element AI Inc., Montreal (CA)

(72) Inventors: Eric ROBERT, Montreal (CA); Jean-Sébastien BÉJEAU, Montreal (CA)

(73) Assignee: Element AI Inc., Montreal, QC (CA)

(21) Appl. No.: 17/259,968

(22) PCT Filed: Jul. 16, 2019
(86) PCT No.: PCT/CA2019/050978

§ 371 Date: Jan. 13, 2021

Related U.S. Application Data
(60) Provisional application No. 62/698,516, filed on Jul. 16, 2018.

(51) Int. Cl. G06K 9/62; G06N 3/08; G06N 3/04

(52) U.S. Cl. CPC G06K 9/6228; G06K 9/6259; G06N 3/0454; G06N 3/08; G06K 9/6202

(57) ABSTRACT

Systems and methods for selecting at least one unlabeled data object from a set of unlabeled data objects. The present invention receives a set of unlabeled data objects and identifies at least one data object in the set that is considered to differ from the others. The at least one data object is selected for further processing, which may include labeling processes. In some embodiments, the data objects are passed through at least one representation-generating module, and the resulting representations are compared to each other. Differences between the representations are evaluated against at least one criterion. If the differences meet the at least one criterion, corresponding data objects are considered to differ from the others and are then selected for further processing. In some implementations, a sample set of sample data objects may be used. In some implementations, the at least one representation-generating module may comprise a neural network.

### TECHNICAL FIELD

The present invention relates to unlabeled data. More specifically, the present invention relates to systems and methods for selecting unlabeled data objects to undergo further processing.

### BACKGROUND

The field of machine learning is a burgeoning one. Daily, more and more uses for machine learning are being discovered. Unfortunately, to properly use machine learning, data sets suitable for training are required to ensure that systems accurately and properly accomplish their tasks. As an example, for systems that recognize cars within images, training data sets of labeled images containing cars are needed. Similarly, to train systems that, for example, track the number of trucks crossing a border, data sets of labeled images containing trucks are required.

As is known in the field, these labeled images are used so that, by exposing systems to multiple images of the same item in varying contexts, the systems can learn how to recognize that item. However, as is also known in the field, obtaining labeled images which can be used for training machine learning systems is not only difficult, it can also be quite expensive. In many instances, such labeled images are manually labeled, i.e., labels are assigned to each image by a person. Since data sets can sometimes include thousands of images, manually labeling these data sets can be a very time-consuming task.

It should be clear that labeling video frames also runs into the same issues. As an example, a 15-minute video running at 24 frames per second will have 21,600 frames. If each frame is to be labeled so that the video can be used as a training data set, manually labeling the 21,600 frames will take hours if not days.

It should also be clear that other tasks relating to the creation of training data sets are also subject to the same issues. As an example, if a machine learning system requires images that have items to be recognized as being bounded by bounding boxes, then creating that training data set of images will require a person to manually place bounding boxes within each of multiple images. If thousands of images will require such bounding boxes to result in a suitable training data set, this will, of course, require hundreds of man-hours of work.

Additionally, a great deal of the labeling work would be redundant. That is, many if not all of the data objects in a certain data set have at least one feature in common between them. For instance, the 15-minute video described above could show the same ‘red car’ in the same position and location within each of the 21,600 frames. Labeling each instance of ‘the red car’ would therefore be an extremely repetitive task for a human. Human labelers are unlikely to sustain their focus for the length of time required to complete such tasks. As a result, there is a high probability of inaccurate or sloppy labeling when human labelers are used.

Thus, methods and systems for labeling data that require much less human involvement have been developed. Some such methods and systems can extrapolate labels for sets of unlabeled data objects based on a small number of already-labeled data objects within those sets.

However, there remains a need for methods and systems that can select which of the unlabeled data objects in a set should be initially labeled, or which should undergo other further processing. Preferably, such systems and methods would select outlying data objects (that is, data objects that are considered to differ from the majority of the data objects in the set).

### SUMMARY

The present invention provides systems and methods for selecting at least one unlabeled data object from a set of unlabeled data objects. The present invention receives a set of unlabeled data objects and identifies at least one data object in the set that is considered to differ from the others. The at least one data object is then selected for further processing, which may include labeling processes. In some embodiments, the data objects are passed through at least one representation-generating module, and the resulting representations are compared to each other. Differences between the representations are evaluated against at least one criterion. If the differences meet the at least one criterion, corresponding data objects are considered to differ from the others. The at least one corresponding data object is then selected for further processing. In some implementations, a sample set of sample data objects may also be used. Additionally, in some implementations, the at least one representation-generating module may comprise a neural network.

In a first aspect, the present invention provides a method for selecting at least one selected unlabeled data object from a set of unlabeled data objects, the method comprising the steps of:

(a) receiving said set;

(b) analyzing said unlabeled data objects from said set to identify at least one unlabeled data object that differs from others in said set; and

(c) selecting said at least one unlabeled data object from said set as said at least one selected unlabeled data object for further processing,

wherein all of said unlabeled data objects in said set are of a same data type and wherein all of said unlabeled data objects have at least one feature in common.

In a second aspect, the present invention provides a system for selecting at least one selected unlabeled data object from a set of unlabeled data objects, the system comprising:
at least one representation-generating module for generating a plurality of representations, each of said plurality of representations representing at least one unlabeled data object from said set;
a comparison module for comparing at least one of said plurality of representations to at least one other of said plurality of representations; and
a selection module for selecting said at least one unlabeled data object as said selected unlabeled data object for further processing, based on at least one result from said comparison module,

wherein all of said unlabeled data objects in said set are of a same data type and all of said unlabeled data objects have at least one feature in common.

In a third aspect, the present invention provides non-transitory computer-readable media having encoded thereon computer-readable and computer-executable instructions, which, when executed, implement a method for selecting at least one selected unlabeled data object from a set of unlabeled data objects, the method comprising the steps of:

(a) receiving said set;

(b) analyzing said unlabeled data objects from said set to identify at least one unlabeled data object that differs from others in said set; and

(c) selecting said at least one unlabeled data object from said set as said at least one selected unlabeled data object for further processing,

wherein all of said unlabeled data objects in said set are of a same data type and wherein all of said unlabeled data objects have at least one feature in common.

### BRIEF DESCRIPTION OF THE DRAWINGS

The present invention will now be described by reference to the following figures, in which identical reference numerals refer to identical elements and in which:

FIG. 1 is a block diagram of one embodiment of a system according to one aspect of the invention;

FIG. 2 is a block diagram of another embodiment of the system of FIG. 1;

FIG. 3 is a block diagram of another embodiment of the system of FIG. 1;

FIG. 4 is a flowchart detailing a method according to one aspect of the invention;

FIG. 5 is a flowchart detailing an embodiment of the method in FIG. 4;

FIG. 6 is a flowchart detailing another embodiment of the method of FIG. 4; and

FIG. 7 is a flowchart detailing a further embodiment of the method of FIG. 4.

### DETAILED DESCRIPTION

The present invention provides methods and systems for selecting at least one unlabeled data object from a set of unlabeled data objects. The at least one selected unlabeled data object can then undergo further processing. That further processing may include the application of labels to the at least one selected unlabeled data object. The at least one selected unlabeled data object is considered to differ from the other unlabeled data objects in the set. There are multiple ways of determining that considered difference.

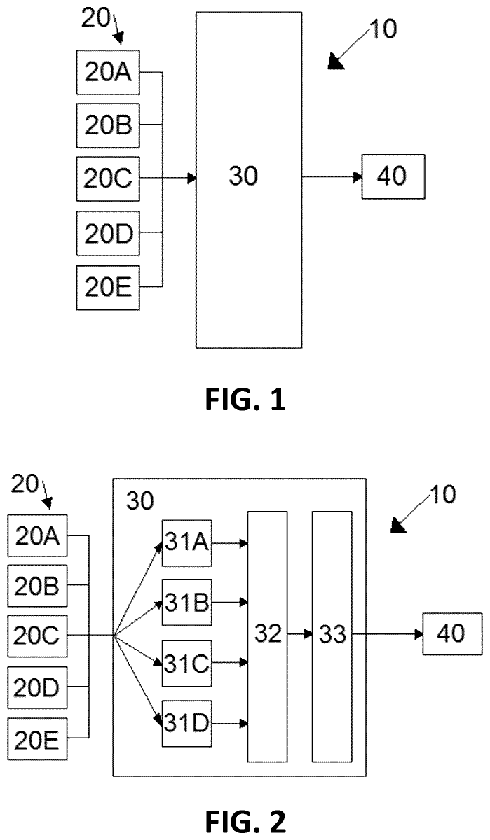

Referring to FIG. 1, one embodiment of a system that forms one aspect of the invention is illustrated. The system 10 receives a set 20 of unlabeled data objects 20A-20E at an execution module 30. The execution module 30 then compares the unlabeled data objects to each other. If one of the unlabeled data objects 20A-20E is considered to differ from the others in the set 20, the execution module 30 selects that one unlabeled data object as a selected unlabeled data object 40. That selected unlabeled data object 40 can then be sent on for further processing. That further processing may be performed by a human or by an automated process.

The present invention looks for data objects that are different from others in the set, to increase the utility of each label added. As discussed above, data objects that are to be labeled typically have at least one feature in common. In some cases, those features may be identical in different data objects (for instance, a feature in one image may be in the same position and location in another image). As should be understood, relabeling identical features may not provide a noticeable increase in the ‘knowledge’ of the system. Thus, for efficiency, labels are preferably added to those features which provide ‘new’ information or to those features that render one data object dissimilar to another data object in the set. That ‘new’ information may be present in various ways, including but not limited to: features which do not exist in other data object, features which appear differently in other data objects, and features that render one data object sufficiently dissimilar to other data objects. Data objects containing features that provide a sufficient degree of ‘new information’ or which are sufficiently dissimilar to the other data objects can thus be considered ‘outlying data objects’. These outlying data objects are then preferably selected for labeling and/or other further processing. (Note that the degree of ‘new information’ or dissimilarity considered ‘sufficient’ may vary with context.)

It should be noted that FIG. 1 is a simplified and stylized image. In particular, FIG. 1 shows only five unlabeled data objects (20A-20E) in the set 20. As discussed above, data sets may contain thousands of data objects, or more. Additionally, the terms “data object” and “data objects”, as used herein, should not be construed as limiting the possible data type of the objects in the set 20. The data objects in the present invention can be any type of data, including: text data; image data; text and at least one image; video data; audio data; medical imaging data; unidimensional data; multi-dimensional data; and/or combinations thereof. For easier internal comparison, however, all data objects in the set 20 are preferably of a same or similar type of data. Additionally, it is preferred that all data objects in the set 20 have at least one common feature. For instance, if data object 20A is an image showing a cat, it is preferred that all other data objects 20B-20E are also images showing at least one cat.

The execution module 30 can be configured in multiple ways. In one embodiment, the execution module 30 is configured to randomly select one of the data objects in the set 20. In such an embodiment, for instance, the execution module 30 may select data object 20D at random from the set 20.

Another embodiment of the system of the invention is detailed in FIG. 2. The system 10 receives a set 20 of unlabeled data objects 20A-20E and outputs a selected unlabeled data object 40, as in FIG. 1. Unlike in FIG. 1, however, the execution module 30 in FIG. 2 comprises multiple internal modules. In particular, the execution module 30 comprises a plurality of representation-generating modules 31A-31D, a comparison module 32, and a selection module 33. The representation-generating modules receive the set 20 and generate representations of each data object in the set 20. The representations are passed to the comparison module 32, which compares a representation of one data object to other representations of the same data object. The results of the comparison are then passed to the selection module 33. (The results of the comparison can be, for instance, one or more tensors containing difference values for each pair of representations.) The selection module determines if the results of the comparison meet at least one criterion. If the at least one criterion is met, the selection module 32 selects that data object to be the at least one selected unlabeled data object 40. Further processing, which may include labeling processes, can then be performed on the selected unlabeled data object 40.

It should again be clear that FIG. 2 is visually simplified. The implementation shown uses four representation-generating modules 31A-31D. Some implementations of this embodiment, however, may have as few as one or two representation-generating modules. Other implementations may have more than four. The representation-generating modules 31A-31D all process input data in the same way. However, all of the representation-generating modules are configured to have at least one different initial parameter from each other. For instance, representation-generating module 31A may have initial parameters of (0.5, 10), while representation-generating module 31B has initial parameters of (0.5, 0.2), and representation-generating module 31C has initial parameters of (0.75, 0.2). (Again, as should be clear, these values are purely exemplary. Representation-generating modules may have one or more initial parameters having any suitable value.) In some implementations, the initial parameters may be randomized.

The representation of a data object produced by one of the representation-generating modules depends on that data object and on the initial parameters of the representation-generating module. For clarity, if the initial parameters were not present or were all identical, the representation-generating modules would generate identical representations of a single input data object. However, as the representation-generating modules are configured to have slightly different initial parameters, they will thus produce slightly different representations of the same input data object.

In the implementation shown in FIG. 2, each representation-generating module 31A-31D receives data objects 20A-20E from the set 20. Each representation-generating module 31A-31D then independently generates a representation of each data object. Each group of representations originating from a single data object may be thought of as a “data subset”. For instance, passing the entire data set 20 (i.e., data objects 20A-20E) through the representation-generating modules 31A-31D would result in 20 different representations, grouped into 5 data subsets. One data subset would contain four separate representations of data object 20A, one from each representation-generating module 31A-31D. There would also be another data subset containing four separate representations of data object 20B, another data subset containing four separate representations of data object 20C, and so on.

Once generated by the representation-generating modules 31A-31D, the representations and/or data subsets are passed to the comparison module 32. Upon receiving the representations, the comparison module 32 compares a representation of a single data object to other representations of the same data object (that is, to other representations within its data subset). In some implementations, however, the comparison module 32 may also compare representations across data subsets.

Results of these comparisons are then sent to the selection module 32, which evaluates them against at least one criterion. In some implementations, the at least one criterion is a difference threshold. As noted above, due to the slightly different initial configurations of the representation-generating modules 31A-31D, all representations of a data object will have slight differences. In most cases, however, the differences between representations of the same object will be minor. Thus, if two representations of a single input data object are unusually different from each other, that data object is considered to differ from the other data objects in the set 20. For instance, if the differences between two representations of a single input data object are above a certain difference threshold, the data object can be considered to be different from others in the set 20.

The at least one criterion does not have to be a threshold value, however. In some implementations, the criterion can be “which data subset has the largest difference value(s) between its representations?”. For instance, if differences between representations of data object 20A are larger than differences between representations in other data subsets, the data object 20A may be selected for further processing. It should be clear that, in this variant that does not use a threshold value, the data object whose representations are most different with one another is selected. As an example, assume data object A has a subset AA containing representations A1, A2, and A3 generated from data object A. Assume that data object B has a subset BB containing representations B1, B2, B3 generated from data object B. Assume, as well, that data object C has a subset CC containing representations C1, C2, C3 generated from data object C. If, after comparing within each subset, the data object whose differences within its subset is the greatest will be selected. For the example, if differences within subset AA are quantified to be 0.5, differences within subset BB are quantified to be 0.25, and differences within subset CC are quantified to be 0.1, then, since the differences within subset AA is 0.5, then data object A is selected.

In other implementations, multiple criteria may be evaluated simultaneously. For instance, in one implementation, a difference threshold may be predetermined. The concept in this variant is that the data object whose differences in its representations meet or exceed the predetermined threshold value will be selected. Using the data in the example above, if the predetermined difference threshold is, for example, 0.3, then data object A would be selected since it is the only data object whose representations have differences that is at least 0.3. However if none of the differences between representations from a certain data set meet that predetermined difference threshold, then other considerations may be taken into account. In such a case, the unlabeled data object with the greatest difference between its representations (i.e., the unlabeled data object corresponding to the data subset with the highest differences between its subset members) may be selected as the selected unlabeled data object 40. As an example, again using the data above, if the predetermined difference threshold is 0.75, then none of the data objects in the example would qualify to be selected as none of their difference values meet or exceed the predetermined threshold. Given this circumstance, data object A would be selected since it has the greatest or largest difference within its subset (i.e. the differences for subset AA is 0.5 and this is greater than the differences for either of subsets BB or CC).

In a further alternative, if none of the differences meet a predetermined threshold or if none of the data objects meet the criteria, a random selection from the available data objects may then be made. In the example above, any one of data objects A, B, or C may be randomly selected if none of the differences for these data objects meets the predetermined threshold. Yet a further alternative would be, if none of the data objects meets the criteria, instead of a random selection, the last data object assessed would be selected. Thus, in the example given above, if it is assumed that the data objects were assessed in the order of C, B, and then A, then A would be the final data object assessed. If none of the data objects meet the criteria, then the data object A would be selected as it would be the last data object assessed.

A further alternative to the above methods would make use of clustering. For this alternative, a metric would be selected by which to measure each data object using the data object representations. Then, the metric for each data object would be used to “map” that data object's position. This “map” would produce clusters of data object positions. Euclidean distances between each data object's position in the map and each of the clusters formed would be calculated and the data object that is farthest from any of the clusters would be selected.

In some implementations, the representation-generating modules 31A-31D generate representations of all of the data objects in the set 20 in a single batch. The comparison module 32 then receives the batch of representations and compares each data object's representations independently. In such implementations, the representation-generating modules 31A-31D and the comparison module 32 can be in communication with a storage module for storing representations for later use.

In other implementations, the representation-generating modules 31A-31D may generate representations of the data objects in the set 20 in multiple batches. In such implementations, several data objects may be received at once. The representations of those data objects may then be generated and stored for later comparisons, and/or sent directly to the comparison module 32.

In still other implementations, the representation-generating modules 31A-31D generate representations of the data objects in the set 20 in a sequential manner. That is, the representation-generating modules 31A-31D receive data object 20A, generate its representations, and pass those representations to the comparison module 32. The selection module 33 evaluates the results of that comparison, and determines whether the at least one criterion is met. If so, the selection module selects data object 20A for further processing. Alternatively, if the representations of data object 20A do not meet the at least one criterion, a new data object from the set 20 (e.g., data object 20B) is passed to the representation-generating modules 31A-31D. That new data object would then be processed in the same way as data object 20A.

As should be noted, the system 10 can select more than one unlabeled data object for further processing at a single time. For instance, if a set of 100 data objects were processed in a single batch, 20 of those data objects may be found to meet a certain difference threshold. In such a case, all 20 outliers could then be sent to a human, an automated system, or some other system, for further processing.

In some implementations, the representation-generating modules comprise trained neural networks. As is well-known in the art, neural networks typically comprise many layers. Each layer comprises multiple nodes, and performs certain operations on the data that each layer receives. A neural network can be configured so that its output is a “representation” or “embedding” of the original input data. The degree of simplification depends on the number and type of layers and the operations they perform. As is also well-known, neural networks are typically “trained” to perform a certain task by processing a “training set” and by receiving feedback related to that processing. The training set is a set of data of a same or similar type as the set of data to be processed. Additionally, a neural network typically has at least one associated “hyperparameter” (i.e., an initial parameter or weight) before the training process begins.

As discussed above, the representation-generating modules 31A-31D are preferably configured so that, given a single data object as input, the representations of that data object are approximately similar to each other. In some implementations where multiple neural networks are used, all of the neural networks may be trained on the same training set and may have different hyperparameters. In some implementations, these different hyperparameters may be randomized. The differences between the hyperparameters mean that each representation-generating module will generate a slightly different representation of each data object. The use of a single training set, however, limits the possible differences between the representations of a single data object, for most similar data objects. Thus, where two representations of a single data object are unusually different from each other, it can be concluded that the data object they represent is itself different from most other similar data objects. That data object can thus be considered an outlier for the set. (Note again that more than one outlier may be identified at one time.) As discussed above, such outliers can be considered to provide more information than the “typical” data objects in the set. Therefore, the present invention can select these outlying data objects as selected unlabeled data objects for further processing.

Additionally, in other implementations that use neural networks as representation-generating modules, one different ‘initial parameter’ may be the type or structure of neural network used. The person skilled in the art will understand that many different well-known neural network architectures may be used. In some implementations, each of the representation-generating modules may use different internal architectures. As an example of such an implementation, representation-generating module 31A may be a neural network with a VGG16 architecture, while representation-generating module 31B has an Inception v3 architecture, 31C has an architecture based on a ResNet model, and 31D has an architecture based on a network-in-network model. In other implementations, however, some of the representation-generating modules may use the same or similar architectures. For instance, representation-generating modules 31A, 31B, and 31C may all have VGG19 architectures while module 31D may have a ResNet-34 architecture.

In other implementations of the present invention, the representation-generating modules comprise rule-based modules that are specifically configured to generate slightly varying representations of the same input data object. In still other implementations, the representation-generating modules comprise both neural network elements and rule-based elements.

Additionally, in some implementations, the representations of the data objects are mathematical representations, such as numeric tensors. In other implementations, however, the representations may be other forms of data, depending on the configuration of the representation-generating module.

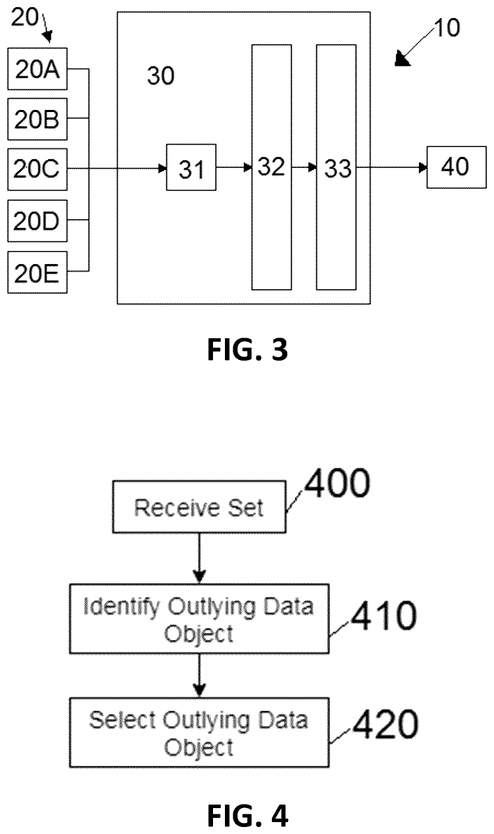

Another embodiment of the system of the invention is shown in FIG. 3. As in FIGS. 1 and 2, this embodiment of the system 10 takes a set of unlabeled data objects 20 and outputs at least one selected unlabeled data object 40 from that set. However, the configuration of the execution module 30 in FIG. 3 is different from that in FIG. 2.

In FIG. 3, the execution module 30 comprises only one representation-generating module 31, a comparison module 32, and a selection module 33. In this embodiment, each representation of a data object that is generated is an “activation map” for the representation-generating module 31 when processing that data object. That is, the representation of a data object is a representation of the response of the representation-generating module 31 to that data object itself

In some implementations of this embodiment, a neural network is used as the representation-generating module 31. In such an implementation, the activation map can be thought of as a map of the internal nodes in the network. As would be evident to the person skilled in the art, a high value in one area of a data object's activation map would indicate that a corresponding node in the neural network was activated while processing that data object. A low value, conversely, would indicate that a corresponding node was not activated while processing that data object. Thus, an activation map would show a data object's overall ‘path’ through the network. However, again, in some implementations, the representation-generating module 31 can comprise a rule-based module, or a combination of rule-based and neural network elements. In such implementations, the activation maps would be configured differently, but still represent the representation-generating module 31's response.

Multiple activation maps can be created, with each map corresponding to a separate data object from the set 20. The multiple maps can then be compared to each other by the comparison module 32. When the representation-generating module 31 has been properly configured, most of the activation maps for a single data set 20 should appear approximately similar. The results of the comparison can then be passed to the selection module 33. The selection module 33 will then evaluate the results of the comparison against at least one criterion, as described above. When comparison results meet that at least one criterion, the selection module 33 can select the related data object to be the selected unlabeled data object 40. Again, in some implementations, the representation-generating module 31 and the comparison module 32 can be in communication with a storage module for storing activation maps.

In other implementations, rather than comparing multiple activation maps from data objects in the set 20 to each other, the comparison module 32 compares a single data object's map to an “aggregate sample map”. This aggregate sample map is created by generating individual activation maps corresponding to each data object in a sample set, using the representation-generating module 31. Those individual maps are then aggregated together to thereby produce the aggregate map.

The sample set is a set of known data objects of same or similar type as the data objects in the set 20. Additionally, all of the data objects in the sample set preferably have at least one feature in common with the unlabeled data objects in the set 20. If the representation-generating module 31 comprises a neural network, the sample set may be related to the training set. The aggregate map thus represents a ‘typical response’ of the representation-generating module 31 to a ‘typical data object’. Therefore, if an activation map for a data object in the set 20 is different enough from the aggregate map to meet the at least one criterion (as evaluated by the selection module 33), that data object can be considered to be ‘atypical’ (i.e., an outlier), and can thus be selected for further processing.

It should be clear to the person skilled in the art that the various modules discussed above may be combined together, or further broken down. For instance, the comparison module 32 and the selection module 33 could be combined together. Alternatively, the selection module 33 could be separated into an “evaluation module” and a “selection module”. Such combinations and/or separations would not substantially affect the present invention. Further, the present invention should be understood as encompassing all such combinations, re-combinations, separations, and similar.

Referring now to FIG. 4, a flowchart is illustrated that details a method according to one aspect of the invention. At step 400, a set of data objects is received. At least one outlying data object (one that is considered to differ from other data objects in the set) is identified at step 410, and selected at step 420 for further processing.

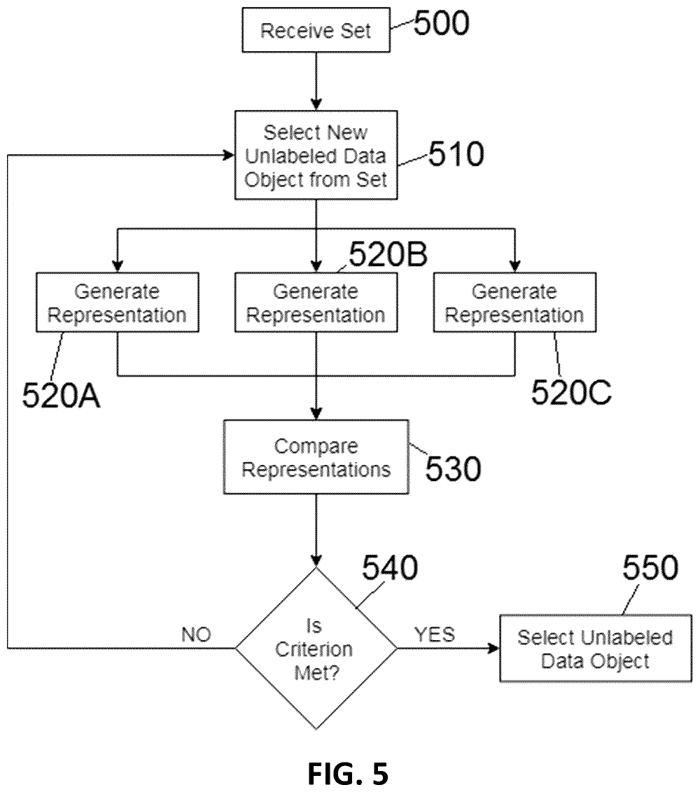

FIG. 5 is another flowchart detailing an embodiment of the method in FIG. 4. The embodiment shown in FIG. 5 corresponds to the system in FIG. 2. At step 500, the set of data objects is received. One of the data objects in that set is selected at step 510, and then passed to multiple independent representation-generating modules. At steps 520A, 520B, and 520C, those representation-generating modules independently generate representations of the data object selected at step 510. (As should again be clear, the implied use of three representation-generating modules in FIG. 5 should not be taken as limiting the invention. Three are shown in this Figure for visual simplicity.)

The representations generated at steps 520A, 520B, and 520C (i.e., the data subset for the unlabeled data object selected at step 510) are then compared to each other at step 530. The results of those comparisons, again, may in some implementations be a numeric tensor of difference values. Other formats of the results are, however, also possible. At step 540, the comparison results are evaluated against at least one criterion, as described above. Again, the at least one criterion may include a difference threshold or other metric applied within a single data subset. The at least one criterion may also include metrics related to more than one data subset (such as a “largest difference between all datasets” metric). In such a case, various data subsets may be generated and compared, either in batches or sequentially.

If the results of step 530 meet the at least one criterion at step 540, at least one corresponding data object is selected at step 550. If the results do not meet the at least one criterion, however, the method returns to step 510 and a new data object from the set is selected for processing. This process repeats until at least one data object is selected for further processing at step 550.

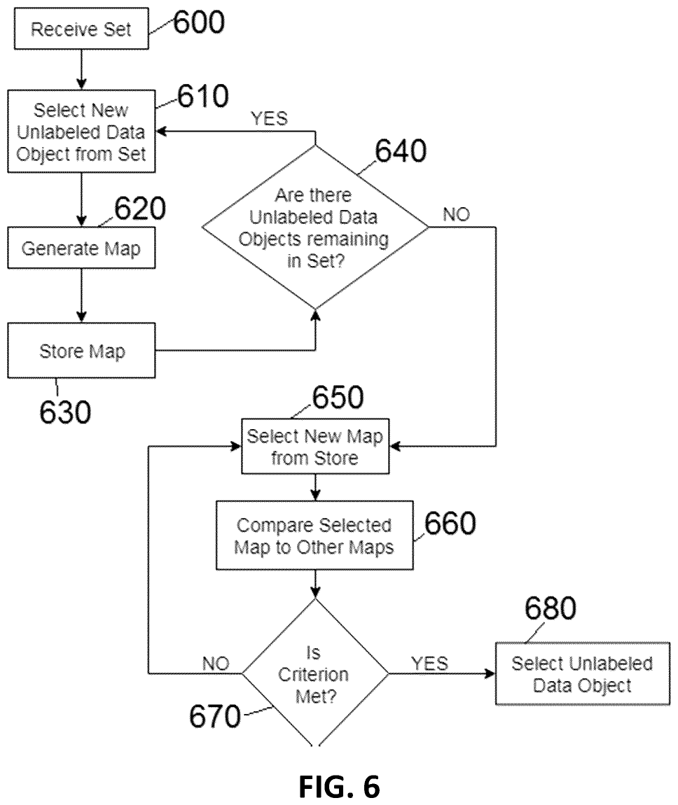

FIG. 6 is another flowchart which details an implementation of another embodiment of the method in FIG. 4. This embodiment corresponds to the system outlined in FIG. 3. At step 600, the data set is received. An unlabeled data object is selected from the data set at step 610. An activation map corresponding to that data object is then generated at step 620, and stored in a storage module at step 630.

Then, at step 640, the data set is examined. If there are unlabeled data objects remaining in the set (i.e., data objects for which activation maps have not yet been generated), the method returns to step 610 and a new data object is selected from the set. This cycle (steps 610-640) repeats until activation maps have been generated for all data objects in the set. In other implementations, of course, as would be clear to a person skilled in the art, the examination step 640 could search for only a certain number of data objects, or for a certain cycle duration, or for other similar criteria.

Returning to the implementation in FIG. 6, however, once there are activation maps for all data objects in the set, one of those maps can be selected at step 650. At step 660, the selected map is compared to other activation maps. The comparison results are evaluated at step 670. If the at least one criterion is met, as described above, the data object corresponding to the selected map is selected for further processing at step 680. If the at least one criterion is not met, the method returns to step 650 and a new map is selected. This cycle (steps 650-670) repeats until at least one data object is selected at step 680.

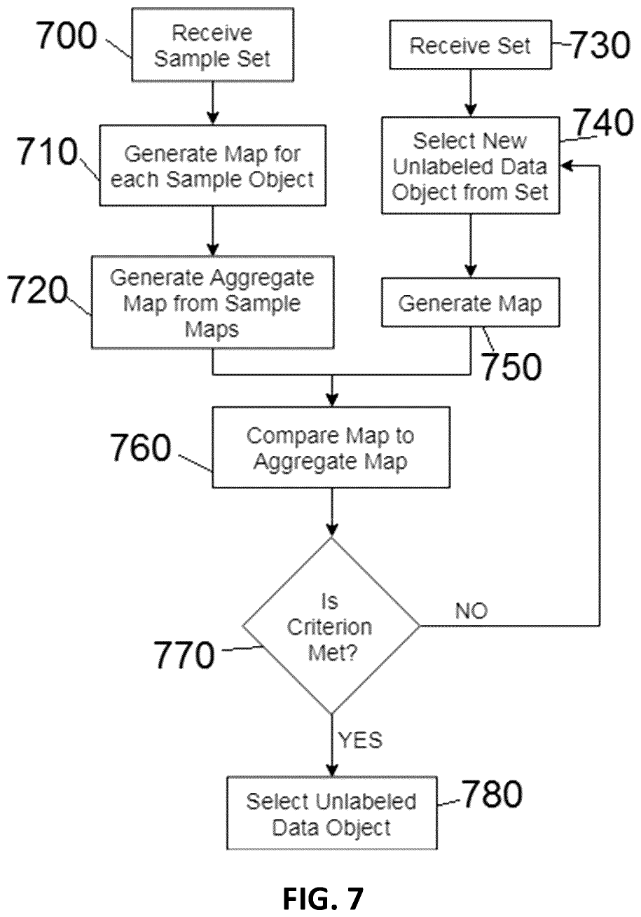

FIG. 7 is another flowchart, detailing another embodiment of the method of FIG. 4. This embodiment receives a sample set at step 700 and generates maps for each sample object in the sample set, at step 710. At step 720, the maps for the sample objects are aggregated together, to thereby produce an aggregate map.

At step 730, a data set is received. A new data object from that set is selected at step 740, and a corresponding activation map is generated at step 750. At step 760, that activation map is compared to the aggregate map from step 720. The results of that comparison are evaluated at step 770. If the at least one criterion is met, the data object is selected for further processing at step 780. If the at least one criterion is not met, the method returns to step 740 and a new data object is selected from the set. This cycle (steps 740-770) repeats until at least one data object is selected (i.e., until at least one criterion is met).

It should be clear that the various aspects of the present invention may be implemented as software modules in an overall software system. As such, the present invention may thus take the form of computer executable instructions that, when executed, implements various software modules with predefined functions.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for selecting at least one selected unlabeled data object from a set of unlabeled data objects, the method comprising the steps of:
(a) receiving said set;
(b) analyzing said unlabeled data objects from said set to identify at least one unlabeled data object that differs from others in said set; and
(c) selecting said at least one unlabeled data object from said set as said at least one selected unlabeled data object for further processing,
wherein all of said unlabeled data objects in said set are of a same data type and wherein all of said unlabeled data objects have at least one feature in common.

2. The method according to claim 1, wherein said further processing includes applying a label to said at least one selected unlabeled data object.

3. The method according to claim 1, wherein said at least one unlabeled data object is randomly selected in step (b).

4. The method according to claim 1, wherein step (b) further comprises the steps of:
(b.1) passing a first unlabeled data object from said set through a plurality of independent representation-generating modules, to thereby generate a plurality of representations of said first unlabeled data object;
(b.2) comparing a first representation from said plurality of representations to other representations from said plurality of representations, to thereby determine differences between said first representation and said other representations;
(b.3) evaluating said differences against at least one criterion; and (b.4) selecting said first unlabeled data object as said at least one selected unlabeled data object when at least one of said differences meets said at least one criterion.

5. The method according to claim 4, wherein said method further comprises executing the following steps between steps (b.3) and (b.4):
(b.3a) selecting a second unlabeled data object from said set when none of said differences meets said at least one criterion; and
(b.3b) repeating steps (b.1)-(b.3a) with said second unlabeled data object in place of said first unlabeled data object until said at least one criterion is met.

6. The method according to claim 4, wherein said method further comprises executing the following steps between steps (b.2) and (b.3):
(b.2a) storing said differences in a storage module;
(b.2b) receiving a new unlabeled data object from said set;
(b.2c) repeating steps (b.1)-(b.2b) with said new unlabeled data object in place of said first unlabeled data object, until no new unlabeled data objects remain in said set.

7. The method according to claim 6, wherein said at least one criterion is based on all differences in said storage module.

8. The method according to claim 4, wherein:
said representation-generating modules are trained neural networks;
all of said neural networks have been trained on a same training set, wherein said training set comprises training data objects, and wherein all of said training data objects are of said same data type;
each of said neural networks has at least one initial parameter; and
for each pair of said neural networks, a first initial parameter of a first neural network in said pair differs from a second initial parameter of a second neural network in said pair.

9. The method according to claim 1, wherein step (b) further comprises the steps of:
(b.1) passing each unlabeled data object from said set through a representation-generating module to thereby generate a plurality of activation maps, wherein each of said plurality of activation maps of activation maps represents a response of said representation-generating module to a single corresponding unlabeled data object;
(b.2) comparing each activation map in said plurality of activation maps to other activation maps in said plurality of activation maps; and
(b.3) selecting at least one specific unlabeled data object as said at least one selected unlabeled data object when a difference between an activation map corresponding to said at least one specific unlabeled data object and at least one other activation map meets at least one criterion.

10. The method according to claim 1, wherein step (b) further comprises the steps of:
(b.1) passing at least one unlabeled data object from said set of unlabeled data objects through said representation-generating module to thereby generate a plurality of activation maps, wherein each of said plurality of activation maps represents a response of said representation-generating module to a corresponding unlabeled data object;
(b.2) comparing each of said plurality of activation maps to an aggregate map; and
(b.3) selecting at least one specific unlabeled data object when a difference between said aggregate map and an activation map corresponding to said at least one specific unlabeled data object meets at least one criterion,
wherein said aggregate map is created by:
receiving a sample set of sample data objects, wherein said sample data objects are of said same data type;
passing each sample data object through a representation-generating module, to thereby generate a plurality of sample activation maps, wherein each of said plurality of sample activation maps represents a response of said representation-generating module to a corresponding sample data object; and
aggregating said plurality of sample activation maps to thereby produce an aggregate map.

11. The method according to claim 1, wherein said representation-generating module is a trained neural network.

12. The method according to claim 1, wherein said data type comprises at least one of:
text data;
image data;
text and at least one image;
video data;
audio data;
medical imaging data;
unidimensional data; and
multi-dimensional data.

13. A system for selecting at least one selected unlabeled data object from a set of unlabeled data objects, the system comprising:
at least one representation-generating module for generating a plurality of representations, each of said plurality of representations representing at least one unlabeled data object from said set;
a comparison module for comparing at least one of said plurality of representations to at least one other of said plurality of representations; and
a selection module for selecting said at least one unlabeled data object as said selected unlabeled data object for further processing, based on at least one result from said comparison module,
wherein all of said unlabeled data objects in said set are of a same data type and all of said unlabeled data objects have at least one feature in common.

14. The system according to claim 13, wherein said further processing includes applying a label to said at least one selected unlabeled data object.

15. The system according to claim 13, wherein said selection module randomly selects said at least one selected unlabeled data object from said set of unlabeled data objects.

16. The system according to claim 13, wherein said at least one representation-generating module is a trained neural network.

17. The system according to claim 13, wherein said representations are numeric tensors.

18. The system according to claim 13, wherein said representations are activation maps, each of said activation maps representing a response of said representation-generating module to a single corresponding unlabeled data object.

19. The system according to claim 13, wherein said system further comprises a storage module, said storage module being in communication with said at least one representation-generating module and with said comparison module.

20. The system according to claim 13, wherein said data type comprises at least one of:
text data;
image data;
text and at least one image;
video data;
audio data;
medical imaging data;
unidimensional data; and
multi-dimensional data.
